(19) United States
(12) Patent Application Publication
(10) Pub. No.: US 2007/0079057 A1
(43) Pub. Date: Apr. 5, 2007

(54) Semiconductor memory system and memory module

(76) Inventors: Hermann Ruckerbauer, Moos (DE); Peter Gregorius, Munchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/239,829

(22) Filed: Sep. 30, 2005

(51) Int. Cl. G06F 12/00; G06F 13/00

(52) U.S. Cl. 711/105; 711/167

(57) ABSTRACT

A semiconductor memory system is disclosed. In one embodiment, the semiconductor memory system and memory module of the present invention provides a buffer, wherein at least one write buffer chip on the memory module is only buffering and registering write data, command and address signals written from a memory controller to the memory chips. As read data are written back from each memory chip directly to the memory controller through unidirectional point-to-point read data lines the present semiconductor memory system achieves a low latency as compared with a fully buffered DIMM concept. As read data are only unidirectional a high transmission bandwidth can be achieved.

### FIELD OF THE INVENTION

The present invention relates to a semiconductor memory system in which a memory module carrying a plurality of semiconductor memory chips is connected via a buffer unit to a memory controller by means of point-to-point write data, command and address signal lines and point-to-point read data lines.

### BACKGROUND

For future high-speed memory interfaces, for example DDR4, speed requirements will force to for a unidirectional signaling with a point-to-point connection. This is necessary for signaling integrity, but the multi drop bus used in todays' DDR1, DDR2 and DDR3 memory systems can not be used anymore.

To achieve high storage density, special topologies of semiconductor memory systems are developed, wherein DDR1 and DDR2 systems are proposed to use registered modules to reduce the load on the command and address bus. However, the bidirectional multi drop DQ bus is still limiting the speed and storage density.

There are DDR2/DDR3 systems which use a fully buffered DIMN (FBDIMM). Such a conventional FBDIMM is depicted in the enclosed FIG. 1. As shown, the FBDIMM carries a plurality of memory chips M₁-M₄, each connected to a full buffer FB arranged at a center section of the memory module FBDIMM. The full buffer FB is connected to a memory controller MC by high speed serial links for transmitting write data wD and command and address signal CA from the memory controller MC to the full buffer FB on the FBDIMM and read data rD from the full buffer FB to the memory controller MC. This concept allows high density and high bandwidth but at cost of read latency what is also quite important. Additionally, an advanced memory buffer version of the full buffer FB is quite complex and therefore expensive and only suitable to be used in servers and work stations. For these and other reasons, there is a need for the present invention.

### SUMMARY

In one embodiment, the present invention provides a semiconductor memory system having a memory controller arranged for transmitting serial write data, command and address signal streams through primary point-to-point write data, command and address signal lines and for receiving serial high speed read data signal streams through point-to-point read data lines.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 (already described) schematically illustrates a conventional example of a fully buffered memory module in a semiconductor memory system.

FIG. 2 schematically illustrates a functional block diagram of a first preferred embodiment of the present semiconductor memory system and

FIG. 3 schematically illustrates a functional block diagram of a second preferred embodiment of the present semiconductor memory system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention provides a semiconductor memory system and a memory module which achieve an optimized topology for future memory systems, high storage density and high transmission band width and reduce the complexity of a buffer chip on the memory module and thereby the production costs of the buffered chip.

According to one embodiment of the invention the present invention provides a semiconductor memory system including a memory controller arranged for transmitting serial write data, command and address signal streams through primary point-to-point write data, command and address signal lines and for receiving serial high speed read data signal streams through point-to-point read data lines, a memory module connected to said memory controller by said primary point-to-point write data, command and address signal lines and said point-to-point read data lines and including: a plurality of semiconductor memory chips and a write buffer means adapted for buffering and distributing to said memory chips only said serial write data, command and address signals streams received through said primary point-to-point write data, command and address signal lines from said memory controller, wherein said write buffer means is connected to the plurality of semiconductor memory chips through secondary command and address signal bus lines and secondary write data signal lines, respectively, and to said memory controller through said point-to-point read data lines.

According to the above embodiment the write buffer means is only buffering and registering signals written to the memory chips. High speed read data are written back directly to the memory controller, and therefore the read latency is lower as for the FBDIMM concept. High band width can be achieved in the present memory system since read data are transmitted unidirectional in a point-to-point fashion.

Buffering only written signals in the present write buffer means is advantageous as command and address signals are redundant for each memory chip and write data latency is not limiting the performance of the memory system.

In one embodiment of the present semiconductor memory system, the serial write buffer means distributes the write data signals through the secondary write data signal lines in a point-to-point fashion to each of the memory chips separately and different in time from said command and address signals.

In the present semiconductor memory system it is preferred that said serial write data, command and address signal streams are transmitted from said memory controller to said write buffer means with a double data rate and said write buffer means has the further function to translate the double data rate to a single data rate of the write data, command and address signals distributed to each of the memory chips.

Further, in one embodiment of the present semiconductor memory system said write buffer means additionally receives from the memory controller a write clock signal through primary write clock signal lines provided separately from said primary point-to-point write data, command and address signal lines and each of the memory chips supplies to the memory controller a read clock signal through read clock signal lines provided separately from the point-to-point read data lines. The read clock signal lines are connected in a point-to-point fashion from each memory chip to the memory controller.

In view of their high frequency and integrity, in one embodiment the write clock signal and the read clock signal are respectively supplied through differential clock lines.

In one embodiment, the write buffer means comprises at least one write buffer chip arranged at a central location of the memory module.

According to one embodiment of the present semiconductor memory system said plurality of semiconductor memory chips on said memory module are divided into a first and a second part of memory chips, said first part of memory chips being arranged at a first side and said second part of memory chips being arranged at a second side of the memory module, wherein said write buffer means is arranged at a central location of the memory module and comprises a first and second write buffer chip, said first write buffer chip being arranged at the first side of the memory module, associated to the first part of the memory chips and connected thereto by first secondary point-to-point write data signal lines and in common by said secondary command and address signal bus lines and adapted for buffering and transmitting only a first part of the write data signal streams dedicated to the first part of the memory chips through the first secondary point-to-point write data signal lines and buffering and transmitting the whole of the command and address signal streams through the secondary command and address signal bus lines, and said second write buffer chip being arranged at the second side of the memory module, associated to the second part of the memory chips and connected thereto by second secondary point-to-point write data signal lines and in common by said secondary command and address signal bus lines and adapted for buffering and transmitting only a second part of the write data signal streams dedicated to the second part of said memory chips through the second secondary point-to-point write data signal lines and buffering and transmitting the whole of the command and address signal streams through said secondary command and address signal bus lines.

In this embodiment of the present semiconductor memory system the serial write data, command and address signal streams are transmitted from said memory controller to said write buffer chips in a double data rate and the write buffer chips have the function to translate the double data rate to a single data rate of the write data, command and address signals transmitted to each of the memory chips.

Further in one embodiment of the present semiconductor memory system, the first and second write buffer chips additionally receive from the memory controller a write clock signal through primary write clock signal lines provided separately from the primary point-to-point write data, command and address signal lines, and each memory chip supplies to the memory controller a read clock signal through read clock signal lines provided separately from the point-to-point read data lines.

In this embodiment of the present semiconductor memory system advantageously said write clock and read clock signals are respectively supplied through differential clock lines.

The memory chips may comprise for example DDR4-DRAM chips.

According to a second embodiment of the present invention provides as a solution of the above object a memory module comprising
a plurality of semiconductor memory chips arranged for storing write data upon receiving through primary point-to-point write data, command and address signal lines a serial write data, command and address signal stream and for transmitting serial read data upon a read command included in said write data, command and address signal stream through high speed point-to-point read data lines, and
a write buffer means adapted for buffering and distributing to said memory chips only said received serial write data, command and address signal stream, wherein said plurality of semiconductor memory chips are connected to said write buffer means through secondary command and address signal bus lines and through secondary write data signal lines for respectively receiving the buffered command and address signals and buffered write data signals from said write buffer means.

The present semiconductor memory system in accordance with the first embodiment of the invention allows to re-use most of the infrastructure of a semiconductor memory system using the FBDIMM.

The present semiconductor memory system uses the same type of drivers at the memory controller for the command and address signals, needs the same amount of pins at the controllers connector and the command and address signal output is arranged in the middle of the connector.

As concerns the memory module according to a second embodiment of the present invention the same memory concept as today can be used (for example DDR₃, DDR₄), that is no high speed serial links between the memory chips which add latency on the memory chips and no high speed re-drive on the memory chips are required.

The only high-speed connection that is necessary is the point-to-point read data connection to the controller.

In view of the above, the present semiconductor memory system and memory module provide a novel and advantageous concept that is scalable for future semiconductor memory developments.

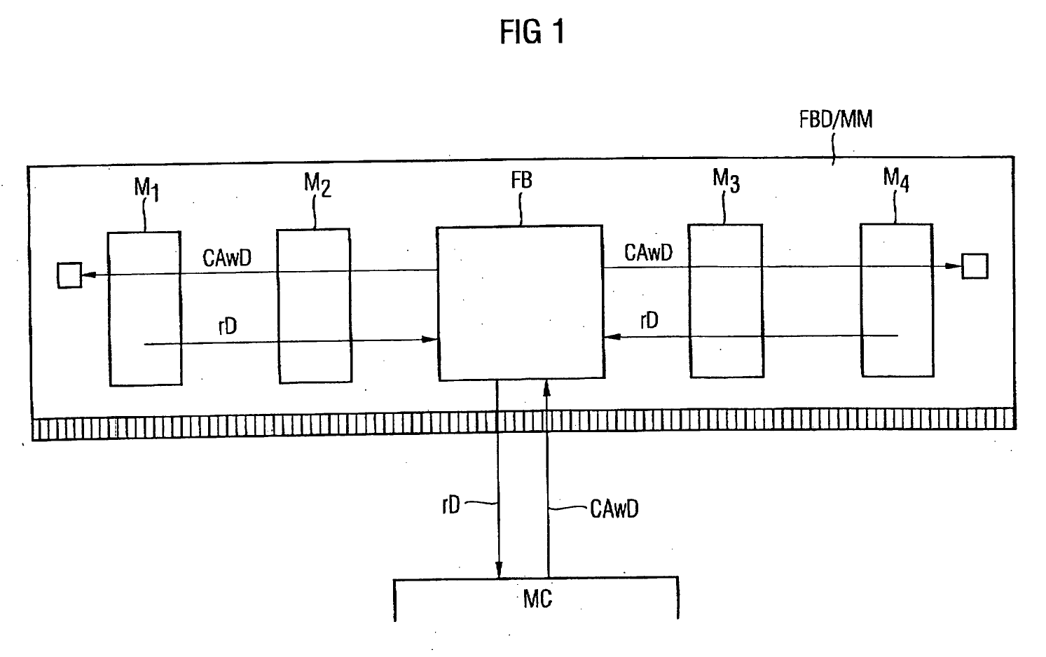

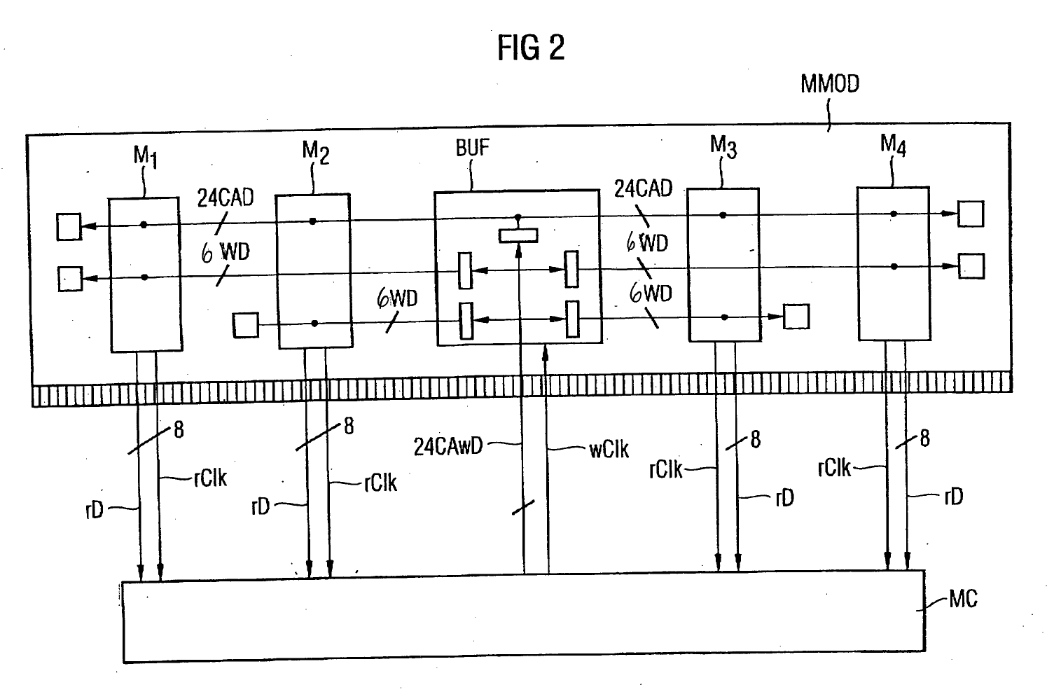

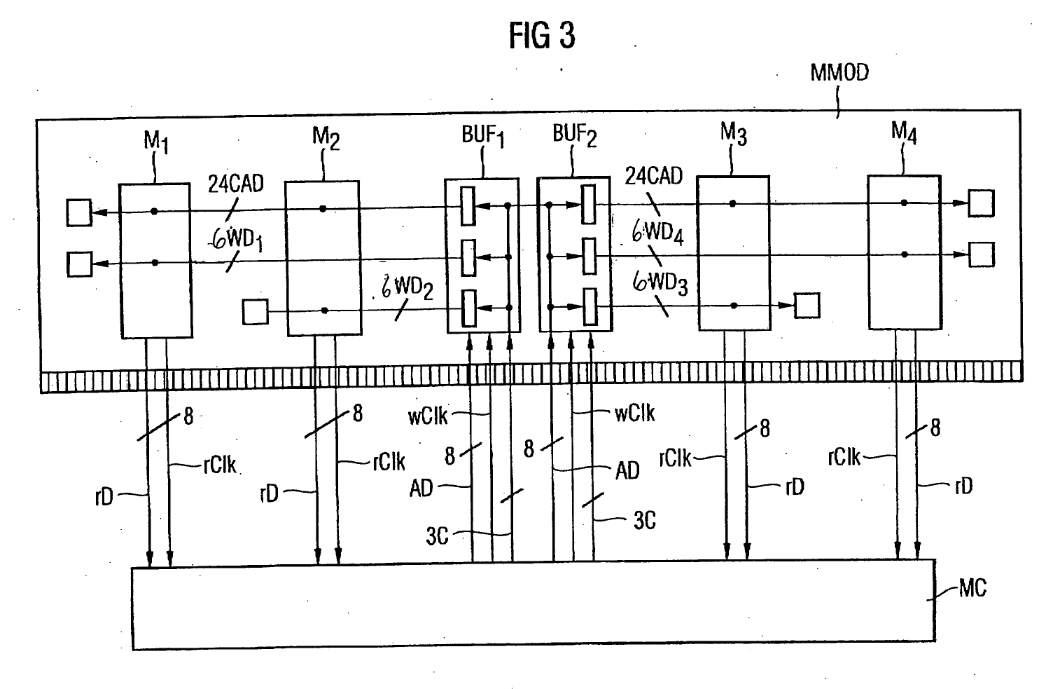

The present invention provides a semiconductor memory system schematically illustrated in the enclosed FIGS. 2 and 3 use a novel buffer concept only buffering and registering signals written to the memory chips. As read data are written back directly to the memory controller, the latency is lower as for the FBDIMM concept described in the introductory part with reference to FIG. 1. Further, as read data are only unidirectional the present semiconductor memory system can achieve high transmission band width.

According to a first embodiment of the present semiconductor memory system schematically illustrated in FIG. 2 a plurality of semiconductor memory chips M₁-M₄ and a write buffer unit, preferably a write buffer chip BUF, are arranged on a memory module MMOD which may be a DIMM memory module.

Write data, command and address signals are supplied from a memory controller MC through primary point-to-point write data, command and address signal lines CAwD to the write buffer chip BUF on the memory module. The memory controller MC further feeds a write clock signal preferably through differential write clock signal lines wClk to the write buffer chip BUF on the memory module MMOD.

The write buffer chip BUF has the function of buffering, registering and distributing to the memory chip M₁-M₄ only the serial write data command and address signal stream CAwD received from the memory controller MC and, if needed, to convert the write data, command and address signals from double data rate to single data rate.

As illustrated, the write buffer chip BUF is placed essentially in a center location of the memory module MMOD and connected to the memory chips M₁, M₂, M₃, M₄ on the left side and the right side of the memory module MMOD by means of secondary command and address signal bus lines CAD and through secondary write data lines wD. That is, the write buffer chip BUF distributes the write data signals through the secondary write data signal lines wD in a point-to-point fashion to each of the memory chips M₁, M₂, M₃, M₄ separately (and different in time) from said command and address signals which are distributed as a whole and in common by means of said secondary command and address signal bus lines CAD. Further, each of the semiconductor memory chips M₁-M₄ transmitts serial high speed read data signals through point-to-point read data lines rD which separately connect each memory chip M₁-M₄ to the memory controller MC in said point-to-point fashion. Together with the serial high speed read data signals each memory chip M₁-M₄ supplies a read clock signal through separate read clock signal lines rClk to the memory controller MC. The read clock signals are preferably supplied differentially through differential read clock signal lines.

In the embodiment depicted in FIG. 2, the primary point-to-point write data, command and address signal lines comprise 24 CAwD lines, the secondary command and address signal bus lines comprise 24 CAD lines connected in common to all memory chips M₁-M₄, and the secondary write data signal connection comprises 6 point-to-point wD data signal lines routed separately from the write buffer chip BUF to each of the memory chips M₁, M₂, M₃ and M₄. The main advantage of this solution is that the pin count of each memory chip is reduced by connecting only 6 wD data signal lines thereto. The smaller bus width is compensated by a high speed transmission of the write data signals.

With the assumption that the transmission speed of the serial write data, command and address signal stream from the memory controller MC to the write buffer chip BUF can be increased to for example maximum 2400 MT/s (Mega Transfers per second) for single ended lines, the memory controller MC transfers one command in 833 ps to the write buffer chip BUF, which command is forwarded in parallel at 2,5 ns to one, two or even four memory chips (2 Rank×4).

When the memory controller MC sends write data wD, always 6 bits are switched to the left branch and to the right branch on the memory module MMOD. To get 24 bits, that is 6 bits to each memory chip, the write buffer chip BUF needs to collect four cycles of write data wD and thereupon sends 6 bits of write data in parallel to each memory chip. That means that the write data can be transferred from the write buffer chip BUF to the memory chips M₁-M₄ with the same transmission speed as from the memory controller MC to the write buffer chip. For every command transmitted from the memory controller MC there are two spots free for write data wD. So, although it is not possible to send continuous write data wD, the primary point-to-point write data, command and address signal lines can transfer the commands combined with the write data wD. The following is an exemplifying calculation of the bandwidth when writing from the write buffer chip BUF to the memory chips M₁, M₂, M₃, M₄:
Assumption: Prefetch of memory chips is 128 bits per access (means BL of 16 for a×8 device).
Read data: point-to-point speed is 2,4 Gb/s; bit time is 416 ps;
   read burst length is 6,6 ns in case of a 16 bit burst at 2,4 Gb/s (2 frames with 8 bits each and 3,3 ns long).
      Write Data
MC to BUF: point-to-point speed is 2,4 Gb/s; bit time is 416 ps;

same 16 bit burst as rD data takes 6,6 ns but supplies 24×16=384 bits to the buffer BUF.

Write Data

BUF to memory chip: CA: 24 bits parallel to all memory chips→slow.
   Assuming one command per 3,3 ns (half read burst) is 300 MHz; But these 24 bits are transferred from the MC to the BUF interface in one bit time (416 ps).
   wD: this means still 7 bit times available for wD before the BUF to memory chip transfer is finished; 7 cycles of 24 bits each=168 bits.
   Every memory chip gets ¼ th of the bits, so 42 bits for every DRAM. Basically, there are sent 8 bits, but the first bit is to be ignored.

Now while the second frame of the first read burst the same on CA again: Another command +42 bits for every memory chip. Now the first rD burst is over. Every memory chip has sent 8×16=128 read data in this time. On the write side two commands and 84 bits are sent to the memory chip, so there are still missing 44 bits to have the 128 bits needed for a complete write burst.

Thereafter the next read burst starts:

During first frame of second read burst: 48 data bits per memory chip are transferred to each memory chip (only 44 needed to complete the first write burst). Second frame of the second burst: one command to all +44 wD to every memory chip.

First frame of third read burst: one command to all +44 wD to every memory chip; second frame of third read burst: 48 data bits per memory chip.

What is done in summa:

3 read bursts on the rD bus;
4 command on the CAwD bus;
2 wD bursts on the CAwD bus;

Assuming a normal relation of 2:1 for read to write data ratio on a DDR 2/3 data bus, there is enough band width on the CAwD bus.

Remarkably, the first embodiment of the present semiconductor memory system does not comprise ECC means which may require an additional x4 memory chip (not shown on the memory module) so that the symmetry of the arrangement of the memory chips is lost.

The second embodiment of the present semiconductor memory system schematically illustrated in the functional block diagram of FIG. 3 differs form the first preferred embodiment of the present semiconductor memory system illustrated in FIG. 2 and described before in that the semiconductor memory chips M₁-M₄ on the memory module MMOD are divided into a first part of memory chips M₁, M₂ and a second part of memory chips M₃, M₄, that first part of memory chips M₁, M₂ being arranged on the left side and the second part of the memory chips M₃, M₄ arranged on the right side of the memory module MMOD and that the write buffer circuit arranged at a central location of the memory module comprises a first write buffer chip BUF₁, and a second write buffer chip BUF₂, wherein the first write buffer chip BUF₁, is arranged on the left side of the memory module MMOD, associated to the first part of the memory chips M₁, M₂ and connected thereto by first secondary point-to-point write signal lines wD₁, wD₂ and in common by the secondary command and address signal bus lines CAD. The first write buffer chip BUF₁ is adapted for buffering and transmitting only a first part of the write data signal stream dedicated to the first part of the memory chips M₁, M₂ through the first secondary point-to-point write data signal lines wD₁, wD₂ and buffering and transmitting the whole of the command and address signal stream through the secondary command and address signal bus lines CAD.

Further, the second write buffer chip BUF₂ is arranged on the right side of the memory module MMOD and associated to the second part of the memory chips M₃, M₄ and respectively connected thereto by second secondary point-to-point write data signal lines wD₃, wD₄ and in common by said secondary command and address signal bus lines. The second write buffer chip is adapted for buffering and distributing only a second part of the write data signal stream dedicated to the second part of the memory chips M₃, M₄ through the second secondary point-to-point write data signal lines wD₃, wD₄ and the whole of the command and address signal stream through the secondary command and address signal bus lines CAD.

The second embodiment of the present semiconductor memory system depicted in FIG. 3 includes 24 secondary command and address signal bus lines routed in common to the first part M₁, M₂ and the second part M₃, M₄ of the memory chips and 6 point-to-point write data signal lines from the first buffer chip BUF₁, separately to each of the first part of the memory chips M₁, M₂ and from the second buffer chip BUF₂ separately to each of the second part of the memory chips M₃, M₄.

The reason of dividing the write buffer into first and second write buffer chips BUF₁, BUF₂ is that the pin count on each buffer chip is reduced, that each buffer chip has a reduced complexity as compared with one common buffer chip (FIG. 2) and that ECC can be solved by providing the first buffer chip BUF₁ for example as a 16+8 register and the second buffer chip BUF₂ as a 20+8 register, in case an additional x4 ECC memory chip is added to the right side of the memory module MMOD. In case the memory module MMOD comprises eight memory chips for data storage and one memory chip for ECC (not shown in FIG. 3), the signal pin count sums up to
9×(8rD+2rClk)+13 CAwD+15 CAwD=118 (read clock signal rClk provided through differential signal lines)

The remaining pins of the connector of the memory module may be used for power supply and shielding purposes.

Even if the first buffer chip requires a different interior construction as compared with that of the second buffer chip, both buffer chips may have identical interface specifications.

The novel concept of the semiconductor memory system and the memory module described above with reference to FIGS. 2 and 3 involves following advantages:
ECC can be solved (additional x4 device);
same memory command and address configuration as today;
requires high speed only in the output interface (rD output);
no re-drive on the memory chip;
evolutionary to DDR3 memory systems;
it should be no real problem to use the same controller, but no read to write turnaround;
very reduced I/O power;
only 4+1 (8+1) high speed output lane (point-to-point rD lines);
simple construction of the write buffer chips (may be DDR-to SDR conversion required).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor memory system comprising:
a memory controller; and
a memory module in communication with the memory controller, the memory module comprising:
a memory chip; and
a write buffer configured to only buffer write signals written from the memory controller to the memory chip.

2. The semiconductor module of claim 1, comprising wherein the write signals include at least one signal from a group of signals consisting of write data, command signals, and address signals.

3. The semiconductor memory system of claim 1, comprising:
a unidirectional point-to-point read data line coupled between the memory controller and the memory chip, wherein read data is written back from the memory chip directly to the memory controller through the unidirectional point-to-point read data line.

4. A semiconductor memory system comprising:
a memory controller arranged for transmitting serial write data, command and address signal streams through primary point-to-point write data, command and address signal lines and for receiving serial high speed read data signal streams through point-to-point read data lines;
a memory module connected to the memory controller by the primary point-to-point write data, command and address signal lines and the point-to-point read data lines and including:
a plurality of semiconductor memory chips; and
a write buffer means adapted for buffering and distributing to the memory chips only the serial write data, command and address signals streams received through the primary point-to-point write data, command and address signal lines from the memory controller, wherein the write buffer means is connected to the plurality of semiconductor memory chips through secondary command and address signal bus lines and through secondary write data signal lines, respectively, and to the memory controller through the point-to-point read data lines.

5. The semiconductor memory system of claim 4, comprising wherein the write buffer means distributes the write data signals through the secondary write data signal lines in a point-to-point fashion to each of the memory chips separately and different in time from the command and address signals.

6. The semiconductor memory system of claim 4, comprising wherein the serial write data, command and address signal streams are transmitted from the memory controller to the write buffer means with a double data rate and the write buffer means has the further function to translate the double data rate to a single data rate of the write data, command and address signals distributed to each of the memory chips.

7. The semiconductor memory system of claim 4, comprising wherein the write buffer means additionally receives from the memory controller a write clock signal through primary write clock signal lines provided separately from the primary point-to-point write data, command and address signal lines, and each of the memory chips supplies to the memory controller a read clock signal through read clock signal lines provided separately from the point-to-point read data lines, wherein the read clock signal lines are connected in a point-to-point fashion from each memory chip to the memory controller.

8. The semiconductor memory system of claim 4, comprising wherein the write clock signal and the read clock signal are respectively supplied through differential clock lines.

9. The semiconductor memory system of claim 4, comprising wherein the write buffer means comprises at least one write buffer chip arranged at a central location of the memory module.

10. The semiconductor memory system of claim 4, comprising wherein the plurality of semiconductor memory chips on the memory module are divided into a first and a second part of memory chips, the first part of memory chips being arranged at a first side and the second part of memory chips being arranged at a second side of the memory module; and
the write buffer means is arranged at a central location of the memory module and comprises a first and second write buffer chip;
the first write buffer chip being arranged at the first side of the memory module,
associated to that first part of the memory chips and connected thereto by first secondary point-to-point write data signal lines and in common by the secondary command and address signal bus lines and adapted for buffering and transmitting only a first part of the write data signal streams dedicated to the first part of the memory chips through the first secondary point-to-point write data signal lines and buffering and transmitting the whole of the command and address signal streams through the secondary command and address signal bus lines; and
the second write buffer chip being arranged at the second side of the memory module, associated to the second part of the memory chips and connected thereto by second secondary point-to-point write data signal lines and in common by the secondary command and address signal bus lines and adapted for buffering and transmitting only a second part of the write data signal streams dedicated to the second part of the memory chips through the second secondary point-to-point write data signal lines and buffering and transmitting the whole of the command and address signal streams through the secondary command and address signal bus lines.

11. The semiconductor memory system of claim 10, comprising wherein the serial write data, command and address signal streams are transmitted from the memory controller to the write buffer chips in a double data rate and the write buffer chips has the function to translate the double data rate to a single data rate of the write data, command and address signals transmitted to each of the memory chips.

12. The semiconductor memory system of claim 10, comprising wherein the first and second write buffer chips additionally receive from the memory controller a write clock signal through primary write clock signal lines provided separately from the primary point-to-point write data, command and address signal lines, and each memory chip supplies to the memory controller a read clock signal through read clock signal lines provided separately from the point-to-point read data lines.

13. The semiconductor memory system of claim 11, comprising wherein the write clock signal and the read clock signal are respectively supplied through differential clock lines.

14. A memory module comprising:
a plurality of semiconductor memory chips arranged for storing write data upon receiving through primary point-to-point write data, command and address signal lines a serial write data, command and address signal stream and for transmitting serial read data upon a read command included in the write data, command and address signal stream through high speed point-to-point read data lines; and
a write buffer means adapted for buffering and distributing to the memory chips only the received serial write data, command and address signal stream, wherein the plurality of semiconductor memory chips are connected to the write buffer means through secondary command and address signal bus lines and through secondary write data signal lines for respectively receiving the buffered command and address signals and buffered write data signals from the write buffer means.

15. The memory module of claim 14, comprising wherein the write buffer means distributes the write data signals through the secondary write data signal lines in a point-to-point fashion to each of the memory chips separately and different in time from the command and address signals.

16. The memory module of claim 14, comprising wherein the memory module receives the serial write data, command and address signals stream at the write buffer means with a double data rate and the write buffer means has the further function to translate the double data rate to a single data rate of the write data, command and address signals distributed to each of the memory chips.

17. The memory module of claim 14, comprising wherein the memory module additionally receives a write clock signal through primary write clock signal lines provided separately from the primary point-to-point write data, command and address signal lines, and each of the memory chips supplies a read clock signal through read clock signal lines provided separately from the point-to-point read data lines, wherein the read clock signal lines are connected in a point-to-point fashion to each memory chip.

18. The memory module of claim 17, comprising wherein the write clock signal and the read clock signal are respectively supplied through differential clock lines.

19. The memory module of claim 14, comprising wherein the write buffer means comprises at least one write buffer chip arranged at a central location of the memory module.

20. The memory module of claim 14, comprising wherein the plurality of semiconductor memory chips on the memory module are divided into a first part of memory chips and a second part of memory chips, the first part of memory chips being arranged at a first side and the second part of memory chips being arranged at a second side of the memory module; and
the write buffer means is arranged at a central location of the memory module and comprises a first and second write buffer chip the first write buffer chip being arranged at the first side of the memory module, associated to that first part of the memory chips and connected thereto by first secondary point-to-point write data signal lines and in common by the secondary command and address signal bus lines and adapted for buffering and transmitting only a first part of the write data signal streams dedicated to the first part of the memory chips through the first secondary point-to-point write data signal lines and buffering and transmitting the whole of the command and address signal streams through the secondary command and address signal bus lines; and
the second write buffer chip being arranged at the second side of the memory module, associated to the second part of the memory chips and connected thereto by second secondary point-to-point write data signal lines and in common by the secondary command and address signal bus lines and adapted for buffering and transmitting only a second part of the write data signal streams dedicated to the second part of the memory chips through the second secondary point-to-point write data signal lines and buffering and transmitting the whole of the command and address signal streams through the secondary command and address signal bus lines.

21. The memory module of claim 20, comprising wherein the first and second write buffer chips receive the serial write data, command and address signals stream in a double data rate and have the further function to translate the double data rate to a single data rate of the write data, command and address signals transmitted to each of the memory chips.

22. The memory module of claim 20, comprising wherein the first and second write buffer chips additionally receive a write clock signal through primary write clock signal lines provided separately from the primary point-to-point write data, command and address signal lines, and each memory chip supplies a read clock signal through read clock signal lines provided separately from the point-to-point read data lines.

23. The memory module of claim 22, comprising wherein the write clock signal and the read clock signal are respectively transmitted through differential clock lines.

24. A semiconductor memory system comprising:
a memory controller; and
a memory module in communication with the memory controller, the memory module comprising:
a memory chip; and
means for buffering only buffer write signals written from the memory controller to the memory chip.

25. The semiconductor module of claim 24, comprising wherein the write signals include at least one signal from a group of signals consisting of write data, command signals, and address signals.

26. The semiconductor memory system of claim 24, comprising:
a unidirectional point-to-point read data line coupled between the memory controller and the memory chip, wherein read data is written back from the memory chip directly to the memory controller through the unidirectional point-to-point read data line.
